(19) United States
(12) Patent Application Publication
(10) Pub. No.: US 2012/0109421 A1
(43) Pub. Date: May 3, 2012

(54) Traffic congestion reduction system

(76) Inventor: Kenneth Scarola, Murrysville, PA (US)

(21) Appl. No.: 13/317,791

(22) Filed: Oct. 28, 2011

Related U.S. Application Data
(60) Provisional application No. 61/456,212, filed on Nov. 3, 2010.

(51) Int. Cl. G08G 1/00; B60K 31/00

(52) U.S. Cl. 701/2; 701/96

(57) ABSTRACT

A wireless/automated method and system of synchronizing the speed and acceleration/deceleration of an unlimited number of preceding/trailing vehicles, to achieve ‘mechanical like’ coupling, comparable to railroad cars. This includes wireless transmitting of the speed and notification of acceleration/deceleration of a preceding vehicle to a trailing vehicle, automated response to the speed and acceleration/deceleration of a preceding vehicle by a trailing vehicle so that the trailing vehicle accelerates/decelerates in near simultaneous synchronization with the preceding vehicle, and alerting the driver to automated vehicle acceleration.

### RELATED APPLICATION

This application claims priority under 35 U.S.C. §119(e), from U.S. Provisional Application 61/456,212 filed Nov. 3, 2010 for “Traffic Congestion Reduction System”.

### BACKGROUND

The present invention relates to methods and apparatus for reducing vehicle traffic congestion by the automated control of the spacing between successive vehicles. Reducing traffic congestion also reduces the frequency of motor vehicle deceleration and acceleration, and thereby increases vehicle fuel economy and reduces environmental emissions.

### SUMMARY

The congestion reduction system that I disclose reduces congestion, increases economy, and also improves vehicle safety by the host or trailing vehicle sensing the rate of speed change of the preceding vehicle and reacting faster than humanly possible, to avoid vehicle collisions. The congestion reduction system requires no special roadway infrastructure, no pre-organized vehicle platoons, and no platoon lead vehicles. Vehicles with my system can coexist with unequipped vehicles. The congestion reduction system adapts techniques used in mission critical safety systems to essentially eliminate the potential for unsafe failure conditions.

To implement my system and method, a motor vehicle is equipped with two independent computers and associated electro-mechanical couplers, each employing diverse technology from the other: Computer #1 normally controls vehicle acceleration, speed and braking to reduce traffic congestion while maintaining safe vehicle performance. Computer #2 will independently override the acceleration and speed control signals of Computer #1 and independently control vehicle braking to ensure no single failure within the congestion reduction system can result in an unsafe vehicle condition. Redundant and diverse computer and electro-mechanical coupling technology significantly reduces the probability that a defect exists that would commonly affect the safety features of both control functions.

The congestion reduction system computer technology allows vehicles to accelerate and decelerate without human delays associated with inattentiveness or reaction time. This allows vehicles to operate in closer proximity at all speeds, without reducing safety. The congestion reduction system enables current roads to accommodate more vehicles, all operating at higher speeds, than previously possible.

One embodiment is directed to a wireless/automated method of synchronizing the speed and acceleration/deceleration of an unlimited number of preceding/trailing vehicles, to achieve “mechanical like” coupling, comparable to railroad cars. “Acceleration and deceleration” can be more generally described as “rate of speed change”. This includes wireless transmitting of the speed and notification of acceleration/deceleration of a preceding vehicle to a trailing vehicle, automated response to the speed and acceleration/deceleration of a preceding vehicle by a trailing vehicle so that the trailing vehicle accelerates/decelerates in near simultaneous synchronization with the preceding vehicle, and alerting the driver to automated vehicle acceleration. Since each vehicle operates autonomously, transmitting its speed (including any acceleration delays) only to its succeeding vehicle, differing lag in each vehicle (for any reason, including vehicle performance differences such as that of motor cycles compared to eighteen wheel trucks) is inherently accommodated to maximize the acceleration rate for the entire group of vehicles. In addition, since the trailing vehicle does not need to measure and calculate preceding vehicle acceleration/deceleration, this method allows vehicles to travel in closer proximity than previous methods commonly used in adaptive cruise control technology. Faster vehicle acceleration and closer vehicle proximity increase roadway throughput. The exact inherent characteristic of the preceding vehicle transmitted as reference data in standardized format to a standard receiving format in the trailing vehicle avoids the need for the trailing vehicle to make real-time approximations based on sensor data from detection of the behavior of the preceding vehicle. The basic tracking method to determine the baseline safe stopping distance is known, but this method of adjusting that baseline using the transmitted/received data to achieve a reduced safe stopping distance is new. The novelty is achieving a reduced safe stopping distance based on the transmitted data.

Another embodiment is directed to a wireless/automated method of near simultaneous acceleration of an unlimited number of vehicles, in response to the transition of a traffic light from red to green. This includes a method of alerting the driver of a stopped lead vehicle to the traffic light transition, and a method of ensuring the driver of the lead vehicle permits automated vehicle acceleration. This also includes a method of controlling the braking and brake release of all stopped trailing vehicles, and alerting the drivers of the stopped trailing vehicles to automated vehicle acceleration. This embodiment builds upon the features described above, to achieve faster vehicle acceleration, and thereby increase roadway throughput at traffic light controlled intersections.

A further embodiment is directed to a wireless/automated method of speed control for an unlimited number of vehicles in areas of known traffic congestion, such as hills and tunnels. This includes a method of ensuring the vehicle speed is maintained for a predetermined distance without the need for multiple control devices along the path of the roadway, and a method of alerting the driver to automated vehicle acceleration. The system and method can also be used temporarily in a temporary installation in areas of anticipated roadway traffic congestion, such as vehicle accident sites and roadway construction sites. This includes a method of ensuring the vehicle speed is maintained for a predetermined distance without the need for multiple control devices along the path of the roadway, a method of alerting the driver to automated vehicle acceleration, and a method of allowing the vehicle speed demand to be field adjusted to accommodate local site roadway conditions. This embodiment builds upon the features described above, to ensure vehicle speed is maintained, and thereby increases roadway throughput in areas where traffic slow-down commonly occurs.

Another aspect includes the option of allowing the end user to define the maximum rate of host vehicle acceleration for all automated acceleration control functions.

A further aspect includes a method of minimizing the safe driving distance between vehicles on a roadway, and thereby maximizing the vehicle throughput capacity of the roadway. This includes a method of integrating the measurement techniques employed in adaptive cruise control technology with a wireless/automated method of instantly notifying a trailing vehicle that a preceding vehicle has initiated deceleration. This not only eliminates human reaction time, but also eliminates deceleration sensing time from the determination of host vehicle stopping distance, as is necessary when current adaptive cruise control systems are employed without the additional inventive features of the congestion reduction system. The invention also includes the option of allowing the end user to define a minimum safe stopping distance multiplier that proportionally increases the following distance to the preceding vehicle. This allows end users to gradually adapt to the closer following distance enabled by the congestion reduction system

Yet another aspect is directed to a method of adapting high reliability techniques used in mission critical safety systems of other industries, by integrating diverse automated deceleration/braking methods of previous inventions within the vehicle controls, described above, to reduce the potential for errors in automated deceleration/braking and thereby maximize the safety of the congestion reduction system. This includes integrating diverse methods of measuring the distance and speed of preceding vehicles, integrating diverse methods of limiting host vehicle speed and acceleration, and integrating diverse methods of initiating vehicle deceleration and braking. These diverse methods are controlled by two independent computers. Each computer has independent continuous automatic self-testing. In addition, the two computers continuously compare calculation results to identify failure conditions. When a failure of either computer is identified, the congestion reduction system automatically transfers to full manual driver control with an alarm. These reliability techniques minimize the probability of a congestion reduction system failure that could result in an unsafe condition.

Another feature ensures that manual braking can override all automated speed and acceleration controls through means that are independent of all computer control functions.

A further aspect is directed to a wireless/automated method of merging vehicles onto a roadway with maximum safe speed and minimum safe distance. This includes a wireless/automated method of increasing the distance between congestion reduction system equipped close following vehicles on the roadway to allow an additional vehicle (congestion reduction system equipped or not) to merge, and a method to limit this control to the vehicles on the appropriate left or right side of the merging vehicle.

Another aspect is a wireless/automated method of facilitating vehicle lane changing. This includes a wireless/automated method of increasing the distance between congestion reduction system equipped close following vehicles on a roadway to allow an additional vehicle (congestion reduction system equipped or not) to merge into the same lane, and a method to limit this control to the vehicles on the appropriate left or right side of the merging vehicle.

Yet another aspect is deployment of the congestion reduction system in a non-homogeneous environment that includes vehicles equipped with some inventive features and vehicles that are not. This feature integrates adaptive cruise control technology for tracking a preceding vehicle (not congestion reduction system equipped) by a trailing vehicle (with congestion reduction system) to allow the trailing vehicle to match the acceleration/deceleration and speed of the preceding vehicle, without receiving any transmitted data from the preceding vehicle. Other congestion reduction system inventive features allow unequipped vehicles to merge with a group of congestion reduction system equipped vehicles that are traveling in close proximity.

### BRIEF DESCRIPTION OF THE DRAWING

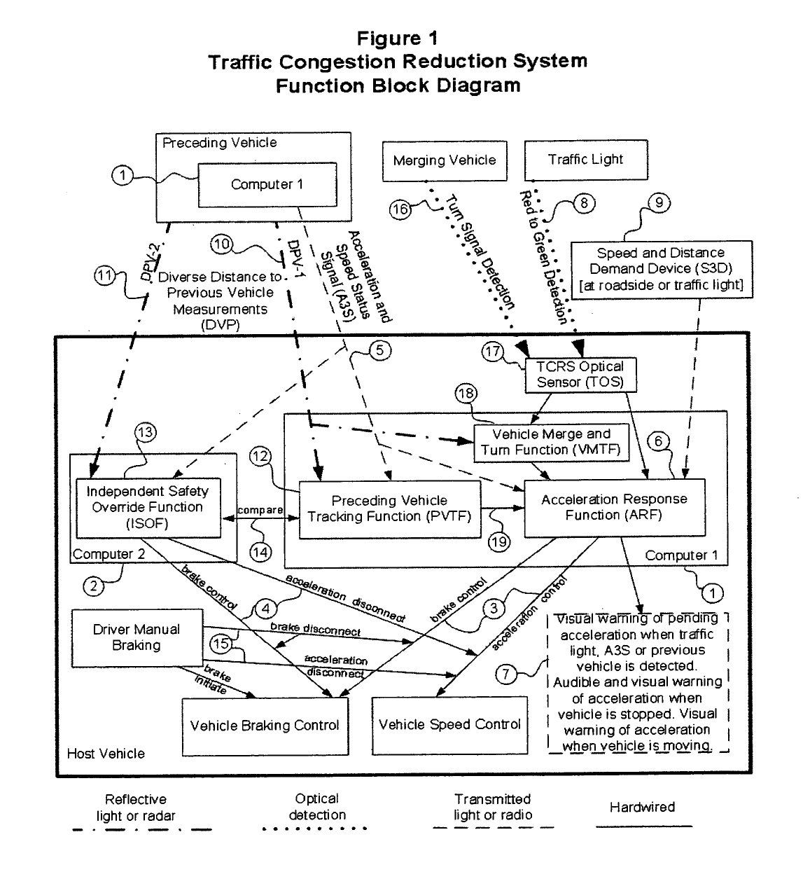

The key components and functions of an illustrative embodiment of the congestion reduction system are described below and shown in FIG. 1.

### DETAILED DESCRIPTION

### Acceleration and Speed Status Signal (A3S)

Computer #1 in each vehicle 1 continuously calculates and transmits an Acceleration and Speed Status Signal (A3S) 5. The A3S 5 includes the speed of the host vehicle and notification of host vehicle acceleration (or deceleration). The A3S 5also includes the host vehicle braking class (determined based on required stopping distance), which is used in determining the safe vehicle stopping distance for the trailing vehicle (discussed further below). The A3S 5 is a short range signal that can only be received by an adjacent trailing vehicle, also equipped with the congestion reduction system.

The speed of the host vehicle is determined by conventional electronic sensing of mechanical drive shaft or wheel rotation (e.g., time duration between rotation intervals). Acceleration and deceleration are determined by speed changes over a fixed time duration.

To transmit speed and acceleration/deceleration information, the rear of the preceding vehicle is equipped with a narrow directional transmission device, such as infrared or RFID. The signal is received by a compatible receiver located on the front of the trailing vehicle.

### Acceleration Response Function (ARF)

Computer #1 in each vehicle 1 executes the Acceleration Response Function (ARF) 6. When a group of vehicles is stopped or slowed, such as at a traffic light or in highway traffic congestion, the ARF 6 of the trailing vehicle responds to the A3S 5 from only the preceding vehicle to almost instantaneously initiate acceleration (or deceleration) and rapidly achieve and maintain the same speed as the preceding vehicle. In a like manner, the trailing vehicle continuously transmits an A3S 5 only to its adjacent trailing vehicle. This process of preceding vehicle A3S 6 transmission and trailing vehicle ARF 6 response continues successively (and near instantaneously) for each vehicle in the group. The result is that the entire group of vehicles accelerates (or decelerates) almost simultaneously, similar to a group of mechanically linked railway cars. However, since each vehicle also transmits its speed update to its adjacent trailing vehicle 100 times each second, the varying performance characteristics of each vehicle in the group (e.g., motor cycles, 18 wheel trucks, manual transmission vehicles) are automatically compensated, resulting in the entire group of vehicles accelerating as rapidly as possible. The ARF 6 eliminates traffic delays that are commonly due to inattentive or slow reacting drivers; this is frequently referred to as the “slinky affect”.

When the ARF 6 determines that the vehicle is stopped and it detects an A3S 5 from a preceding vehicle, the ARF 6 illuminates a visual cue 7 to notify the vehicle driver that it has engaged the vehicle brakes and will control brake release and vehicle acceleration. The driver responds to this cue by releasing manual vehicle braking, thereby allowing the ARF 6 to control the vehicle. The ARF 6 generates an audible and visual warning 7 to alert the driver when vehicle acceleration is initiated. The driver can override vehicle acceleration at any time by manually braking 15, as explained in “Braking Disconnect Function”. When the vehicle is moving, there are visual acceleration warnings but no audible warnings 7, since the driver is already alert to vehicle motion.

The ARF 6 also improves motor vehicle safety, since A3S 5 signals are updated by the preceding vehicle and processed by the ARF 6 in the trailing vehicle a minimum of 100 times each second. This feature allows all vehicles to respond to deceleration changes faster than humanly possible, thereby allowing vehicles to operate safely with a closer following distance to the preceding vehicle. The combination of A3S 5 and ARF 6 also allow vehicles to operate at a much closer following distance than achievable by current adaptive cruise control technology, which requires the trailing vehicle to measure and calculate the distance, speed and acceleration/deceleration of the preceding vehicle.

Computer #1 within the host vehicle 1 detects and processes the A3S 5 signal received from the preceding vehicle a minimum of 100 times each second, to initiate corresponding acceleration/deceleration of the host vehicle. Since the A3S 5 also includes the speed of the preceding vehicle, the ARF 6 within Computer #1 continuously establishes and adjusts the speed target for the host vehicle.

The ARF 6 limits the acceleration rate of the host vehicle to a predetermined value regardless of the difference between the host vehicle's current speed and the target speed. The default predetermined value considers fuel economy, passenger comfort and safety. The value is adjustable by user preference settings in the ARF 6. Acceleration by the ARF 6 is also limited by vehicle engine RPM; this is especially important to accommodate manual transmission vehicles.

Acceleration is maintained by the ARF 6 to achieve the last A3S 5 speed demand. The ARF 6 will continue to adjust the speed of the host vehicle as long as additional A3S 5 are received. When the vehicle achieves the last A3S 5 speed demand (and no more are received), speed control is turned over to the vehicle's driver or to the vehicle's cruise control system (if it is engaged). This feature of the ARF 6 accommodates lane changes or turns by the preceding vehicle; at this point, what was a trailing vehicle may become a lead vehicle.

Acceleration, deceleration, braking and speed control use electro-mechanical coupling techniques common in conventional vehicle cruise control and collision warning systems 3, 4, 15.

The ARF 6 also responds to other speed and acceleration signals, as described below.

### Speed and Distance Demand Device (S3D)

The Speed and Distance Demand Device (S3D) 9 is an external roadside device that enhances overall congestion reduction system performance, for roadway areas with especially troublesome traffic congestion.

The A3S 5 described above, which is generated by the lead vehicle, eliminates traffic delays due to inattentive drivers in trailing vehicles. The S3D 9 ensures there are no acceleration delays due to inattentiveness by the driver of the lead vehicle. For example, when a traffic light changes from red to green, a single S3D 9 transmits a green light notification and the roadway speed limit. The ARF 6 of the actual lead vehicle responds to the S3D 9 by notifying the driver to manually release the vehicle brakes; once released the ARF will initiate acceleration to rapidly achieve the roadway speed limit. The S3D 9 employs the same narrow directional transmission device as the A3S 5 that can only be received by the lead vehicle. Trailing vehicles respond to the actual preceding vehicle's A3S 9, as described above.

The ARF 6 does not control vehicle braking in response to the S3D 9 as it does in response to the A3S 5. Therefore, the driver must maintain vehicle braking when the lead vehicle is stopped. When the ARF 6 detects the S3D 9, the ARF 6 illuminates a visual cue 7 to notify the vehicle driver that a traffic light transition cue is pending. When the light transitions from red to green, the ARF 6 response to the S3D 9 alerts the driver to ensuing vehicle acceleration with a visual and audible warning 7. The driver must release the vehicle brake before acceleration will initiate. This response is different than the ARF 6 response to an A3S 5, which will control vehicle braking as described above. This difference allows the driver of the lead vehicle to ensure the intersection is clear of oncoming traffic before allowing acceleration to initiate.

S3Ds 9 can also be placed (preferably permanently) along sections of roadway that are known to cause traffic congestion due to inadvertent driver deceleration, such as when ascending hills or driving in tunnels. In these locations, the S3D 9 will continuously transmit a speed signal that the ARF 6 in each successive passing vehicle will respond to, to maintain the roadway speed limit. The S3D 9 and the response of the ARF 6 in each vehicle, ensure vehicle speed is maintained in these troublesome traffic locations. This will reduce traffic congestion that is common on roadways with hills and tunnels.

Similarly, portable S3Ds 9 can be temporarily installed by emergency responders to vehicle accidents. These temporary S3Ds 9 will keep traffic moving at a safe speed near the site of the accident. This prevents common traffic congestion when vehicles slow down due to “rubber necking”. Portable S3Ds 9 can also be used to keep traffic moving safely at roadway construction sites. The speed setting for portable S3Ds 9 can be adjusted by end-users to accommodate road conditions, weather, and time of day.

The S3D 9 uses the same narrow directional technology used for the A3S 5 transmitter on the rear of any congestion reduction system equipped vehicle, as discussed in “Acceleration and Speed Status Signal”. On the host vehicle, the S3D 9 signal is received by the same receiving device as the A3S 5 from a preceding vehicle.

For permanent installations, the S3D 9 is typically suspended from overhead wires or supports, which are commonly used for traffic lights or road signs. For coordination with traffic lights, the S3D 9 transmits its A3S 5, in synchronization with the traffic light transition from red to green. To achieve this synchronization, the S3D 9 is typically hardwired, to the traffic light controller, however wireless communication can also be employed. For temporary installations the portable S3D 9 is located along the roadside. Alternately, traffic light transition can be detected by an optical sensing device embedded in each vehicle. This is referred to as the congestion reduction system Optical Sensor (TOS) 17. For all conventional traffic light installations, this device will detect the traffic light and notify the congestion reduction system of the light transition, using red color and shape sensing, red to green color change, and illumination position change (red is always illuminated on top, green is always on the bottom of a traffic light). This device uses the same photo sensing technology employed in digital cameras for facial recognition. For unconventional traffic light installations, the traffic light may not be automatically detected by the TOS; the driver will know that the traffic light has not been automatically detected by the absence of the ARF⁶ visual cue 7 described above.

The S3D 9 transmits an acceleration demand and the speed corresponding to the roadway speed limit. The corresponding acceleration of the host vehicle is controlled by the ARF 6, as explained above. To minimize the need for multiple S3D 9 devices along the same roadway, the S3D 9 also transmits a distance signal, which is in addition to the acceleration/deceleration notification and speed signals, previously discussed. The distance signal is used by the ARF 6 to maintain the last speed demand for the last distance demand, and thereby control vehicle speed for a predetermined distance after the location of the S3D 9. Subsequent A3S 5 or S3D 9 signals will override these last demands. The TOS 17 has no knowledge of the roadway speed limit; therefore conservative speed and distance values are preset. This still prompts lead vehicle drivers to release their brake to allow congestion reduction system acceleration after a traffic light transitions from red to green.

The ARF in each vehicle will always respond to the last acceleration/speed demand received, whether that originates from a preceding vehicle or a roadside device. So, if multiple vehicles pass a roadside device, all vehicles will receive the roadside signal, but immediately afterward, the trailing vehicle(s) will receive a new A3S from the preceding vehicle. Therefore, the lead vehicle will respond to the roadside device, for the predetermined speed and distance (since there are no other preceding vehicles), but all trailing vehicles will respond to the A3S from the preceding vehicle, not the roadside device. In the aggregate all vehicles will travel at the speed and acceleration of the lead vehicle, and the lead vehicle is directed by the roadside device.

### Preceding Vehicle Tracking Function (PVTF)

Computer #1 in each vehicle 1 executes the Preceding Vehicle Tracking Function (PVTF) 12. The PVTF 12 calculates the preceding vehicle's speed, acceleration and deceleration based on measurements of host vehicle speed and measured distance to the preceding vehicle.

The ARF 6 uses the signals from the PVTF 12 to regulate the host vehicle speed to ensure the minimum safe stopping distance between vehicles is always maintained. The ARF 6 uses the signals from the PVTF 12 to override any A3S 5 or S3D 9 generated speed or acceleration demands to initiate vehicle deceleration or braking, as necessary.

In addition, the PVTF 12 allows the host vehicle's ARF 6 to maximize speed and minimize distance to vehicles that are not equipped with the congestion reduction system, and are therefore not transmitting an A3S 5. Using this feature, the PVTF 12 facilitates congestion reduction system deployment as discussed in “Deployment”, below.

The congestion reduction system uses two diverse measurements of distance to the preceding vehicle. The method used by the PVTF 12 in Computer #1 is referred to as Distance to Previous Vehicle-1 (DPV-1) 10. DVP-2 11 is discussed later. DVP-1 and 2 measurements 10, 11 are processed a minimum of 100 times each second.

The PVTF 12 uses conventional measurement technology common in adaptive cruise control systems to determine the distance to the preceding vehicle. The speed of the preceding vehicle is calculated by measuring the distance change between sampling intervals. The PVTF 12 combines the preceding vehicle speed with the current speed of the host vehicle and the change in that vehicle speed over the same sampling interval.

The minimum safe stopping distance is determined based on known braking distance and speed relationships, obtained from the vehicle manufacturer or industry safety publications. As in conventional adaptive cruise control systems, this host vehicle stopping distance is adjusted based on the speed of the preceding vehicle and the most optimistic stopping distance for that speed (i.e. the preceding vehicle is assumed to have a very short stopping distance). However, a key distinction from previous adaptive cruise control systems is that if the host vehicle is receiving an A3S 5 from the preceding vehicle, the PVTF 12 allows a significantly reduced stopping distance, since the host vehicle knows the braking class of the preceding vehicle and is immediately notified of preceding vehicle deceleration. The host vehicle can continuously adjust its own rate of deceleration, based on the deceleration rate of the preceding vehicle, which is updated 100 times each second. If the A3S 5 from the preceding vehicle is lost, the PVTF 12 will automatically extend the required stopping distance, but will allow the ARF 6 to maintain vehicle speed control. This is distinguished from host computer failure conditions that would result in full manual driver control.

The PVTF 12 is based on known techniques, such as described in U.S. Pat. No. 7,602,311 (the disclosure of which is incorporated by reference), including conventional electro-mechanical coupling between Computer #1 and the vehicle's speed and braking systems 3. However, the key distinction is the continuous adjustment of safe stopping distance based on the A3S 5. The invention enables the host vehicle to follow more closely during steady speed because it does not rely only on its own ability to detect when braking or deceleration of the preceding vehicle 10 is initiated (based on measurements and calculations, with inherent lag), but it also receives real time notification from the preceding vehicle that it has initiated deceleration and it receives continuous real time updates 5 for the rate of that deceleration.

### Independent Safety Override Function (ISOF)

Computer #2 in each vehicle 2 executes the Independent Safety Override Function (ISOF) 13. Under normal equipment operating conditions, the PVTF 12, described above, will maintain a safe vehicle stopping distance at all times. But if the minimum safe stopping distance is not available, the ISOF 13 overrides the speed and acceleration functions 4 of Computer #1, and independently activates the vehicle's braking system 4. The ISOF 13 will also block the acceleration demands 4 from Computer #1, if acceleration or vehicle speed exceeds predefined limits.

Computer #2 is completely independent of Computer #1, and uses a diverse (compared to Computer #1) distance to preceding vehicle measuring technique (DPV-2) 11 (e.g., laser vs. ultrasonic measurements), a diverse distance control algorithm and diverse electro-mechanical interfaces 4 to disconnect the vehicle's accelerator and actuate the vehicle's brakes. The ISOF 13 also uses diverse measurements of host vehicle acceleration and speed.

The ISOF 13 implements the same minimum distance control functions as the PVTF 12. The calculation of minimum safe stopping distance considers the same parameters as the PVTF 12, but the ISOF 13 uses diverse algorithms. Compared to the PVTF 12, the ISOF 13 uses a different coupling method between the computer and vehicle braking system. As in the PVTF 12, if the ISOF 13 is receiving an A3S 5 from the preceding vehicle, the ISOF 13 allows a significantly reduced stopping distance, since the host vehicle knows the preceding vehicle braking class and is immediately notified of preceding vehicle deceleration. If the A3S 5 from the preceding vehicle is lost, the ISOF 13 will automatically extend the required stopping distance, but will allow Computer #1 to maintain ARF 6 control. This is distinguished from host computer failure conditions that would result in full manual driver control.

The distance control function of the ISOF 13 is based on known techniques, such as described in U.S. Pat. No. 6,292,737 (the disclosure of which is incorporated by reference), including conventional electro-mechanical coupling between Computer #2 and the vehicle's braking system 4. However, the key distinction is the continuous adjustment of safe stopping distance based on the A3S 5, as discussed for the PVTF 12.

To implement the speed and acceleration limitation functions of the ISOF 13, the speed of the host vehicle is determined by conventional electronic sensing of mechanical shaft rotation (e.g. time duration between rotation intervals). The rate of acceleration is determined by speed changes between successive samples. The sensing locations, devices and algorithms of the ISOF 13 are diverse from those of the PVTF 12.

### Braking Disconnect Function (BDF)

As in conventional cruise control systems, any manual activation of the host vehicle's braking system by the vehicle driver will terminate all acceleration and braking functions of the congestion reduction system. The driver can manually reengage the congestion reduction system at any time. The Braking Disconnect Function (BDF) operates completely independently of Computer #1 and #2 and uses a mechanical disconnect mechanism that is independent of the mechanical mechanisms controlled by either computer 15.

As in conventional cruise control systems, the congestion reduction system is manually enabled by the driver, and the driver can manually disable the congestion reduction system at any time by hitting the electronic cancel button. The congestion reduction system is also automatically disconnected if there is a self-detected failure of Computer #1 or #2, or there is a mismatch 14 between the safe stopping distance calculation results of Computers 1 and 2. However, if the A3S 5 is lost by one or both computers, and the uncompensated stopping distances of both computers remain matched, the ARF 6 will remain connected and the safe stopping distance will be adjusted to compensate for loss of the A3S 5. This is distinguished from host computer failure conditions that would disable the congestion reduction system. The driver can also manually disconnect the ARF 6 at any time by depressing the brake pedal which activates the BDF 15. The BDF does not completely disable the congestion reduction system because braking is an expected function of the lead vehicle at traffic light controlled intersections. The BDF is a mechanical device which operates completely independently of Computer #1 and #2. The mechanical disconnect mechanism of the BDF is completely independent of the mechanical mechanisms controlled by either computer 15.

### Vehicle Merge and Turn Function (VMTF)

During normal driving, the minimum distance between vehicles on the highway is maintained by the PVTF 12, described above. Based on the safety features of the PVTF 12, these vehicles are normally traveling in very close proximity.

The Vehicle Merge and Turn Function (VMTF) 18 is used to facilitate vehicle merging for vehicles entering the highway and lane changing for vehicles already on the highway. The VMTF 18 permits vehicles with and without the congestion reduction system to merge. When the driver of a vehicle that wants to merge activates the vehicle's turn signal, the turn signal flashing is detected by the TOS 17 of the front most adjacent vehicle within the group of congestion reduction system equipped vehicles that are traveling in close proximity. The VMTF 18 distinguishes turn signals from brake lights and traffic lights by the repeatable frequency of light intensity changes. The VMTF 18 then signals the ARF 6 which reduces the host vehicle speed and increases its following distance to the preceding vehicle, thereby allowing the new vehicle to merge.

The TOS 17 and VMTF 18 will also detect turn signals from the immediate preceding vehicle, which will result in the ARF 6 increasing the distance to the preceding vehicle, as for merging vehicles. This allows additional maneuvering space for the preceding vehicle to make its turn before the trailing vehicle closes the distance gap to a new preceding vehicle that may be ahead.

Highway entry merging and vehicle lane changes are executed manually, by the host vehicle driver, when the driver judges vehicle spacing in the adjacent lane to be sufficient for merging.

It is noted that since the operator manually controls vehicle merging and vehicle lane changing, the driver will adjust the speed of the host vehicle to accommodate situations where the vehicle(s) already on the highway or in the adjacent lane is not equipped with the congestion reduction system. Merging with vehicles without the congestion reduction system does not require automated distance control for these other vehicles, since these vehicles are typically not in such close proximity to preceding vehicles.

### Deployment

The congestion reduction system will not reach optimum effectiveness until most vehicles are equipped with the special components described above. During the transition period, vehicles with and without the congestion reduction system will coexist on the roadways.

Vehicles with the congestion reduction system will respond to signals from S3Ds 9 and from other vehicles equipped with the congestion reduction system, to achieve minimum acceleration delay. Based on signals from their PVTF 12, these vehicles will also rapidly accelerate to match the speed of unequipped vehicles.

Vehicles equipped with the congestion reduction system will achieve reduced following distance to all other vehicles (equipped with the congestion reduction system or not) based on signals from their PVTF 12 and ISOF 13. The PVTF 12 and ISOF 13 do not require the congestion reduction system in the preceding vehicle. A congestion reduction system equipped vehicle traveling in close proximity to a preceding vehicle will adjust its following distance to allow merging of any other vehicle (equipped with congestion reduction system or not).

Therefore, all congestion reduction system equipped vehicles will require less road space, resulting in less traffic congestion. In addition, the acceleration and speed of congestion reduction system equipped vehicles will help to establish the traffic pace for other unequipped vehicles. The result is that the congestion reduction system will generate traffic congestion reduction benefits, fuel economy benefits and safety benefits from its initial introduction.

These benefits will increase as the number of congestion reduction system equipped vehicles increases. The rate of increase could be accelerated through government tax incentives and by highway restricted lane incentives, such as is customary for high occupancy vehicles (HOV). When there is an adequate number of vehicles equipped with congestion reduction system, lane restrictions could be expanded to prohibit vehicles that are not equipped with congestion reduction system (i.e., a transition from “HOV” lanes to “HOV with congestion reduction system” lanes), thereby further encouraging congestion reduction system deployment to more and more vehicles.

Appendix

Representative Algorithms

The following algorithms are representative for illustrative purposes and are not to be incorporated as such into any claims unless expressly recited therein. The numbers in brackets [ ] refer to the numeric ID's in FIG. 1

1.0 Computer #2 (algorithm executed every 10msec, after the traffic congestion reduction system (TCRS) is manually activated by driver)
1.1 Has driver selected TCRS Cancel Button
   1.1.1 Yes—Terminate Computer #2 functions, disconnect Computer #2 brake control [15]
   1.1.2 No—Continue
1.2 Has driver manually engaged vehicle brakes
   1.2.1 Yes—Terminate Computer #2 brake control [15]
   1.2.2 No—Continue
1.3 ISOF [13]
   1.3.1 Establish Stopping Distance to preceding vehicle based on host vehicle speed and industry safety standards
   1.3.2 Is there an A3S from preceding vehicle [5]
      1.3.2.1 Yes—Establish reduced Stopping Distance that accounts for immediate deceleration notification and braking class of preceding vehicle (with driver preferred distance multiplier)
      1.3.2.2 No—Maintain previous Stopping Distance
   1.3.3 Update ISOF-Stopping Distance for Computer #'s1-2 diagnostic comparison [14]
   1.3.4 Is preceding vehicle decelerating (based on A3S [5]) and is preceding vehicle speed (based on A3S [5]) less than host vehicle speed (with margin for expected ARF response), or is current distance from preceding vehicle (based on DVP-2 [11]) less than Stopping Distance [This step allows Computer #2 to override Computer #1, but this override will not be necessary if Computer #1 has correctly reduced vehicle speed to match the preceding vehicle.]
      1.3.4.1 Ye—Disconnect Computer #1 from Vehicle Speed Control [4] and apply/increase Computer #1 Vehicle Braking Control [4]
      1.3.4.2 No—Maintain Computer #1 connection to Vehicle Speed Control [4] and release Computer #2 Vehicle Braking Control [4]
1.4 Diagnostics
   1.4.1 Is the distance to preceding vehicle based on DVP-2 outside the acceptable tolerance of distance from PVTF (based on DVP-1), is the ISOF-Stopping Distance outside the acceptable tolerance of the PVTF-Stopping Distance [14], or are there any Computer #2 self-diagnostic errors, or has Computer #1 failed
      1.4.1.1 Yes—Terminate Computer #2 processing; this will result in the following inherent fail-safe actions (1) terminate Computer #2 Vehicle Braking Control [4], (2) disconnect Computer #1 Vehicle Speed Control [4], and (3) generate TCRS failure alarm
      1.4.1.2 No—Continue

2.0 Computer #1 (algorithm executed every 10 msec, after TCRS is manually activated by driver)
2.1 Has driver selected TCRS Cancel Button
   2.1.1 Yes—Terminate Computer #1 functions, disconnect Computer #1 brake control and speed control [15]
   2.1.2 No—Continue
2.2 Has driver manually engaged vehicle brakes
   2.2.1 Yes—Disconnect Computer #1 brake control and speed control [15]
   2.2.2 No—Continue
2.3 PVTF [12]
   2.3.1 Establish Stopping Distance to preceding vehicle based on host vehicle speed and industry safety standards
   2.3.2 Is there an A3S from preceding vehicle [5]
      2.3.2.1 Yes—Establish reduced Stopping Distance that accounts for immediate deceleration notification and braking class of preceding vehicle (with driver preferred distance multiplier)
      2.3.2.2 No—Maintain previous Stopping Distance
      2.3.2.3 Update PVTF-Stopping Distance for Computer 1-2 diagnostic comparison [14]
   2.3.3 Is current distance from preceding vehicle (based on DVP-1 [10]) close to Stopping Distance, and is preceding vehicle accelerating or maintaining current speed (based on A3S [5] or PVTF)
      2.3.3.1 Yes—Notify ARF [19] to hold current speed [This allows distance from preceding vehicle to gradually increase during normal ARF acceleration.]
      2.3.3.2 No—Continue
   2.3.4 Is current distance from preceding vehicle (based on DVP-1 [10]) close to Stopping Distance and is preceding vehicle decelerating (based on A3S [5] or PVTF) [This step allows the PVTF to override the ARF's own calculations, but this override will not be necessary if the ARF has correctly reduced or maintained vehicle speed to match the preceding vehicle.]
      2.3.4.1 Yes—Notify ARF [19] to release Vehicle Speed Control [6] [This step does not apply brakes because braking may not be necessary. The need for braking is determined in 2.3.5.]
      2.3.4.2 No—Continue
   2.3.5 Is current distance from preceding vehicle (based on DVP-1 [10]) close to Stopping Distance and is preceding vehicle decelerating (based on A3S [5]) and is preceding vehicle speed (based on A3S [5]) less than host vehicle speed (with margin for expected ARF response), or is current distance from preceding vehicle (based on DVP-1 [10]) less than Stopping Distance [This step allows the PVTF to override the ARF's own calculations, but this override will not be necessary if the ARF has correctly reduced vehicle speed to match the preceding vehicle.]
      2.3.5.1 Yes—Notify ARF [19] to release Vehicle Speed Control [3] and apply/increase Vehicle Braking Control [3] [Since this algorithm is executed every 10 msec, the brake pressure will increase each execution cycle.]
      2.3.5.2 No—Continue
2.4 Diagnostics
   2.4.1 Is the distance to preceding vehicle based on DVP-1 outside the acceptable tolerance of distance from ISOF (based on DVP-2), is the PVTF-Stopping Distance outside the acceptable tolerance of the ISOF-Stopping Distance [14] or are there any Computer #1 self-diagnostic errors [1], or has Computer #2 failed
      2.4.1.1 Yes—Terminate Computer #1 processing; this will result in the following inherent fail-safe actions (1) terminate Computer #1 Vehicle Braking Control [3] and Vehicle Speed Control [3], and (2) generate TCRS failure alarm
      2.4.1.2 No—Continue
2.5 VMTF [18]
   Has the TOS [17] detected a turn signal (from a preceding or adjacent vehicle) and is distance to preceding vehicle (based on DVP-1 [10]) less than pre-established distance for merging/turning
   2.5.1 Yes—Notify ARF [19] to release Vehicle Speed Control [3] [This will increase the distance to the previous vehicle to allow the new vehicle to merge.]
   2.5.2 No—Notify ARF [19] to engage Vehicle Speed Control [3] [When the distance for merging/turning is achieved or the turn signal is extinguished, the ARF will reengage its Vehicle Speed Control to match that of the preceding vehicle. At all times the PVTF will ensure the minimum Stopping Distance is always maintained to the original preceding vehicle or the new merging vehicle.]
2.6 ARF [6]
   2.6.1 Is there a signal from PVTF [19] or VMTF [18] to maintain vehicle speed, release Vehicle Speed Control or apply/increase Vehicle Brake Control
      2.6.1.1 Yes—Respond to PVTF commands [19] or VMTF commands [18], return to 2.1 [There is no need to execute 2.6.2 or 2.6.3, because those steps may result in acceleration. But the PVTF or VMTF have determined that the stopping distance is insufficient, therefore acceleration is unacceptable.]
      2.6.1.2 No—Continue
   2.6.2 Is there an A3S (from a preceding vehicle) [5] or a preceding vehicle detected by PVTF [19], or a roadside S3D [9] (not a traffic light S3D) [This step notifies driver that the TCRS may accelerate the vehicle. But acceleration will not occur until driver releases the brake; this turns control over to TCRS. If brake is not released, TCRS cannot accelerate vehicle (see 2.2.1).]
      2.6.2.1 Yes—Illuminate pending acceleration cue [7]
         2.6.2.1.1 Is host vehicle stopped and is preceding vehicle stopped (based on A3S [5] or PVTF)
         2.6.2.1.1.1 Yes—Engage brake [3] to keep host vehicle stopped [Driver should release brakes based on visual cue (2.6.2.1), since he knows TCRS is controlling the vehicle.]
         2.6.2.1.1.2No—Release brake [3]; match acceleration/deceleration and speed of preceding vehicle based on A3S [5] or PVTF, or accelerate to achieve speed defined by S3D [9] (limit acceleration rate based on default value or user preference, and based on maximum engine RPM); for acceleration illuminate acceleration visual cue [7], for initial acceleration after stop sound audible warning [7]; maintain speed for distance defined by S3D [9]; then disengage ARF [6], turn speed control over to driver or cruise control and extinguish pending acceleration cue
      2.6.2.2 No—Continue
   2.6.3 Is there a traffic light S3D [9] or traffic light detected by TOS [17] [This step will not accelerate vehicle unless driver releases the brake after the traffic light turns green.]
      2.6.3.1 Yes—Illuminate pending acceleration cue [7]
         2.6.3.1.1 Is traffic light green [9, 17]
         2.6.3.1.1.1 Yes—Sound initial acceleration warning [7] [This simply gets the drivers attention; it does not initiate acceleration. This helps to reduce acceleration delays due to inattentiveness of lead driver.]
         2.6.3.1.1.2 No—Continue
         2.6.3.1.2 Is traffic light green [9, 17] and vehicle brake engaged by driver [15] [Driver should not release brake until after light turns green.]
         2.6.3.1.2.1 Yes—Set Driver Safety flag
         2.6.3.1.2.2 No—Continue
         2.6.3.1.3 Is traffic light green [9, 17], Driver Safety flag set (2.6.3.1.1.1) and brake disengaged by driver [15]
         2.6.3.1.3.1 Yes—Accelerate to achieve speed defined by S3D [9] or accelerate to achieve speed predefined for TOS[17] (limit acceleration rate based on default value or user preference, and based on maximum engine RPM); illuminate acceleration visual cue and sound audible warning [7]; maintain speed for distance defined by S3D [9] or predefined for TOS [17]; then disengage ARF [6], turn speed control over to driver or cruise control and extinguish pending acceleration cue
         2.6.3.1.3.2 No—Continue
      2.6.3.2 No—Continue

1. An automated method of synchronizing the speed and rate of speed change of a sequence of preceding and trailing vehicles on a roadway, comprising:
(a) transmitting indicia of the speed and rate of speed change of each preceding vehicle from each said preceding vehicle to an immediately trailing vehicle;
(b) at each trailing vehicle, detecting the indicia of speed and rate of speed change transmission of the preceding vehicle;
(c) in response to the detected indicia, automatically changing the speed of each trailing vehicle for synchronization with the respective preceding vehicle; and
(d) alerting the driver of each trailing vehicle to the automated changing of speed for synchronization with the preceding vehicle.

2. The method of claim 1, wherein
a preceding vehicle has performance characteristics including braking characteristics that are stored as reference data in the preceding vehicle and transmitted to the immediately trailing vehicle; and
the immediately trailing vehicle detects said reference data and in combination with said detected indicia continually synchronizes the trailing vehicle with the preceding vehicle to maintain a safe target separation distance.

3. The method of claim 1, wherein said sequence of vehicles includes a lead vehicle and said sequence responds from a stopped condition at a red traffic light to a transition of the light to green, by
(e) alerting the driver of the stopped lead vehicle to the traffic light transition;
(f) giving the driver of the lead vehicle manual control over initiating automated vehicle acceleration and then automatically controlling vehicle acceleration only after manual initiation;
(g) controlling the braking and brake release of each stopped trailing vehicle;
(h) alerting the driver of each stopped trailing vehicle to automated vehicle acceleration; and
(i) automatically accelerating each stopped trailing vehicle in response to the detection of the indicia of speed and rate of speed change transmission of a respective preceding vehicle.

4. The method of claim 1, performed in an area of roadway traffic congestion, comprising:
(e) with a control device external to the vehicles, changing the speed of a lead vehicle to maintain a target speed for a predetermined distance over a predetermined portion of the roadway prone to traffic congestion;
(f) alerting the lead driver of said change of speed;
(g) automatically accelerating/decelerating each trailing vehicle in response to the detection of the indicia of speed and rate of speed change transmission of a respective preceding vehicle.

5. The method of claim 4, including adjusting the control device to different target speeds depending on at least one of roadway conditions, weather, and time of day.

6. The method of claim 4, wherein the control device is permanently fixed at the roadway.

7. The method of claim 4, wherein the control device is temporarily situated at the roadway.

8. The method of claim 4, wherein only a single control device transmits a control signal to said lead vehicle to maintain the same target speed of all trailing vehicles in the sequence for a predetermined distance over a predetermined portion of the roadway.

9. The method of claim 4, wherein at least temporarily, said control device controls the speed of the lead vehicle for a predetermined distance, and the indicia from that lead vehicle and all preceding vehicles overrides the signal from said control device to maintain the speed of all trailing vehicles for said predetermined distance over said predetermined portion of the roadway.

10. The method of claim 1, including:
(e) in a trailing vehicle, determining the speed and rate of speed change of the preceding vehicle, and the distance to the preceding vehicle, for determining a baseline safe stopping distance between vehicles using diverse techniques;
(f) in said trailing vehicle, determining a change in the speed and rate of change of speed of said trailing vehicle, and the distance to the preceding vehicle, for synchronized deceleration with the preceding vehicle using diverse techniques;
(g) initiating an output signal to reduce the speed and rate of change of speed of said trailing vehicle using diverse techniques;
(h) continually comparing said determinations and output signals of the respective diverse techniques; and
(i) if any of said comparisons indicates a deviation outside a tolerance, automatically transferring control of the vehicle to a safer mode of operation, such as full manual control.

11. The method of claim 1, further comprising:
(e) controlling the distance between vehicles on the roadway to allow an additional vehicle to merge from an entry ramp; and
(f) limiting this control to the vehicles on the roadway that are adjacent to the merging lane of the merging vehicle.

12. The method of claim 11, wherein controlling the distance between vehicles is responsive to a turn signal from the merging vehicle.

13. The method of claim 1, further comprising:
(e) controlling the distance between two vehicles in a first lane on a roadway to allow an adjacent third vehicle on the roadway to merge into the first lane from an adjacent second lane; and
(f) limiting this control to the two vehicles that are adjacent to the third vehicle.

14. The method of claim 13, wherein controlling the distance between vehicles is responsive to a turn signal from the third vehicle.

15. The method of claim 2, wherein said sequence of vehicles includes a lead vehicle and said sequence responds from a stopped condition at a red traffic light to a transition of the light to green, by
(e) alerting the driver of the stopped lead vehicle to the traffic light transition;
(f) giving the driver of the lead vehicle manual control over initiating automated vehicle acceleration;
(g) controlling the braking and brake release of each stopped trailing vehicle;
(h) alerting the driver of each stopped trailing vehicle to automated vehicle acceleration; and
(i) automatically accelerating each stopped trailing vehicle in response to the detection of the indicia of speed and rate of speed change transmission of a respective preceding vehicle.

16. The method of claim 2, including:
(e) in a trailing vehicle, determining the speed and rate of speed change of the preceding vehicle, and the distance to the preceding vehicle, for determining a baseline safe stopping distance between vehicles using diverse techniques;
(f) in said trailing vehicle, determining a change in the speed and rate of change of speed of said trailing vehicle, and the distance to the preceding vehicle, for synchronized deceleration with the preceding vehicle using diverse techniques;
(g) initiating an output signal to reduce the speed and rate of change of speed of said trailing vehicle using diverse techniques;
(h) continually comparing said determinations and output signals of the respective divers techniques; and
(i) if any of said comparisons indicates a deviation outside a tolerance, automatically transferring control of the vehicle to a safer mode of operation.

17. The method of claim 16, wherein either diverse method overrides the synchronized change of speed.

18. The method of claim 16, wherein the safer mode of operation is one of holding current speed, releasing accelerator, applying brakes, or full manual control.

19. A method of merging vehicles in a first lane of a roadway, from an entrance ramp or a second lane of the roadway, comprising:
(a) controlling the distance between first and second vehicles in the first lane to allow a third vehicle to merge into the first lane between said first and second vehicles; and
(b) limiting the distance control to the first and second vehicles; and
(c) establishing and maintaining a safe stopping distance between the first and second vehicles in the first lane and between the second vehicle and the merged third vehicle.

20. A system of synchronizing the speed and acceleration/deceleration of a multiplicity of preceding/trailing vehicles on roadways, each with their own performance characteristics, comprising:
(a) means for transmitting indicia of the speed and acceleration/deceleration of a preceding vehicle to a trailing vehicle;
(b) means responsive to said indicia and said performance characteristics of the preceding vehicle, for the trailing vehicle to match the speed and acceleration/deceleration of the preceding vehicle so that the trailing vehicle automatically accelerates/decelerates in near simultaneous synchronization with the preceding vehicle; and
(c) means for alerting the driver of the trailing vehicle to automated vehicle acceleration/deceleration.
